(19) United States
(12) Patent Application Publication
(10) Pub. No.: US 2025/0012924 A1
(43) Pub. Date: Jan. 9, 2025

(54) LIDAR DETECTION SYSTEM AND METHOD FOR MACHINE SAFETY

(71) Applicant: Stolle Machinery Company, LLC, Centennial, CO (US)

(72) Inventor: Sayon Chandrakanthan, Lakewood, CO (US)

(73) Assignee: Stolle Machinery Company, LLC, Centennial, CO (US)

(21) Appl. No.: 18/219,233

(22) Filed: Jul. 7, 2023

(51) Int. Cl. G01S 17/894; G06T 7/521

(52) U.S. Cl. CPC G01S 17/894; G06T 7/521; G06T 2207/10028

(57) ABSTRACT

A LIDAR (Light Detection and Ranging) detection system for use with a machine includes a LiDAR sensor disposed overhead and structured to scan and create at least one of a three-dimensional (3D) image or a 3D point map of a machine and surroundings thereof, and (ii) a controller communicatively coupled to the LiDAR sensor and structured to collect data including at least one of the 3D image or the 3D point map from the LiDAR sensor, analyze the data, and detect a human, and determine if a detected human is in the vicinity of a hazardous zone associated with the machine.

### FIELD OF THE INVENTION

The disclosed concept relates generally to a system and method for detecting human in vicinity of an equipment and, more particularly, to a system and method of detecting human using LiDAR for machine safety.

### BACKGROUND OF THE INVENTION

Currently, guards and light curtains are used to ensure safety of machine operators and other persons in the work area. Guards are barriers which prevent access to hazardous areas. There are four types of guards: fixed, interlocked, adjustable, and self-adjusting. A fixed guard is a permanent part of a machine and not dependent upon moving parts to function. It can be constructed of sheet metal, screen, wire cloth, bars, plastic or any other materials that can withstand an impact. However, it may interfere with visibility and be limited to specific operations. Further, it needs to be removed for machine adjustment and repair, thereby requiring alternative means of protection for maintenance personnel. An interlocked guard is a mechanical, electrical, hydraulic, pneumatic or other type of detection and safety device. When it is opened or removed, a tripping mechanism and/or power automatically shuts off or disengages, and the machine cannot be restarted until the guard is back in place. However, an interlocked guard requires extensive wiring, careful adjustment and continuous maintenance. An adjustable guard is a barrier that may be adjusted to facilitate a variety of production operations and allow flexibility in accommodating various sizes of stock. However, with the adjustable guard, humans may still enter a dangerous area. Further, it may interfere with visibility. A self-adjusting guard is a barrier that moves according to the size of the material entering the dangerous area. As such, as the operator moves the material into the danger area, the guard is pushed away, providing an opening which is only large enough to admit the material. However, it may interfere with visibility and requires frequent maintenance and adjustment.

A light curtain is an opto-electronic device that detects presence of personnel in the vicinity of a moving machine. FIG. 1 illustrates an exemplary light curtain 200 placed over an exemplary can decorator 2. A can decorator 2 is used for decorating cans and may include an infeed conveyor 15, which receives cans 16 from a can supply (not shown) and directs them to arcuate cradles or pockets 17 along the periphery of spaced parallel rings secured to a pocket wheel 12. The pocket wheel 12 is secured to a continuously rotating mandrel carrier wheel 18, which in turn is keyed to a continuously rotating horizontal drive staff 19. Downstream from the infeed conveyor 15, each spindle or mandrel is in closely spaced axial alignment with an individual pocket 17, and undecorated cans 16 are transferred from the pockets 17 to the mandrels. Suction applied through an axial passage of the mandrel draws the can 16 to a final seated position on the mandrel. While mounted on a mandrel, each can 16 is decorated by being brought into engagement with a blanket (e.g., without limitation, a replaceable adhesive-backed piece of rubber) disposed on a blanket wheel of the multicolor printing unit indicated generally by reference numeral 22. Thereafter, and while still mounted on the mandrels, the outside of each decorated can 16 is coated with a protective film of varnish applied by engagement with the periphery of a varnish applicator roll (not shown) rotating on a shaft 23 in the overvarnish unit indicated generally by reference numeral 24. Cans 16 with decorations and protective coatings thereon are then transferred from the mandrels to suction cups (not shown) mounted adjacent the periphery of a transfer wheel (not shown) rotating on a shaft 28 of a transfer unit 27. From the transfer unit 27 the cans 16 are deposited on generally horizontal pins 29 carried by a chain-type output conveyor 30, which carries the cans 16 through a curing oven (not shown). As such, the can decorator 2 is a high-speed continuous motion machine, including numerous moving parts and motors, and thus can be hazardous to its operator or persons in vicinity of a hazardous zone 40, e.g., without limitation, a zone including the moving parts and motors.

The light curtain 200 is supplied as a pair with a transmitter 210 and a receiver 220. The transmitter 210 is disposed at one corner of the can decorator 2 and projects an array of parallel infrared light beams 230 to the receiver 220 that is disposed at another corner and consists of a plurality of photoelectric cells. When an object breaks one or more beams 230, a stop signal is transmitted to a control panel 50 of the can decorator 2 and the control panel 50 causes the can decorator 2 to shut down. While FIG. 1 shows only one light curtain 200 covering the front side of the can decorator 2, at least three more light curtains 200 surrounding the other three sides of the can decorator 2 are needed in order to effectively protect the humans in the vicinity of the can decorator 2. As such, for effective protection, the light curtains require complex wirings, a large number of sensors and costly installation. Further, the light curtains do not protect against mechanical failure and are limited to machines that can be stopped. In addition, any object can break the beams, thereby possibly resulting in unnecessary shut-downs.

There is a room for improvement in a detection system for a human in the vicinity of possibly hazardous machines.

### SUMMARY OF THE INVENTION

These needs, and others, are met by a LiDAR (Light Detection and Ranging) detection system of a human for use with a machine. The LiDAR detection system includes a LiDAR sensor disposed overhead and comprising a light source structured to emit light to the machine and surroundings thereof, a receiver structured to receive the light reflected and roundtrip data of the light, a scanner structured to scan the machine and the surroundings based on the roundtrip data, and a controller structured to at least measure distance between the machine and the surroundings and create an image of the machine and the surroundings, the LiDAR sensor being structured to detect a human in vicinity of the machine based on the measured distance and the created image, and transmit an alert based on the detection; and a user device communicatively coupled to the LiDAR sensor and disposed on the human, the user device being structured to receive at least the alert.

Another example embodiment of the disclosed concept provides a LiDAR detection system of a human for use with a plurality of machines. The LiDAR detection system includes a LIDAR sensor disposed overhead and comprising a light source structured to emit light to the machines and surroundings thereof, a receiver structured to receive the light reflected and roundtrip data of the light, a scanner structured to scan the machines and the surroundings based on the roundtrip data, and a controller structured to at least measure distance between the machines and the surroundings and create an image of the machines and the surroundings, the LiDAR sensor being structured to detect a human in vicinity of the machines based on the measured distance and the created image, and transmit an alert based on the detection; and a user device communicatively coupled to the LiDAR sensor and disposed on the human, the user device being structured to receive at least the alert.

Yet another example embodiment of the disclosed concept provides a method of detecting a human in vicinity of a machine. The method includes providing a LiDAR detection system that comprises (i) a LiDAR sensor disposed overhead and comprising a light source structured to emit light to the machine and surroundings thereof, a receiver structured to receive the light reflected and roundtrip data of the light, a scanner structured to scan the machine and the surroundings based on the roundtrip data, and a controller structured to at least measure distance between the machine and the surroundings and create an image of the machine and the surroundings, the LiDAR sensor being structured to detect a human in vicinity of the machine based on the measured distance and the created image, and transmit an alert based on the detection, and (ii) a user device communicatively coupled to the LiDAR sensor and disposed on the human, the user device being structured to receive at least the alert. The method further provides detecting a human in vicinity of the machine based on the measured distance and the created image; and transmitting an alert to the human via the user device based on the detection.

### BRIEF DESCRIPTION OF THE DRAWINGS

A full understanding of the invention can be gained from the following description of the preferred embodiments when read in conjunction with the accompanying drawings in which:

FIG. 1 is an exemplary system using a light curtain for detecting a human in the vicinity of a machine using a light curtain;

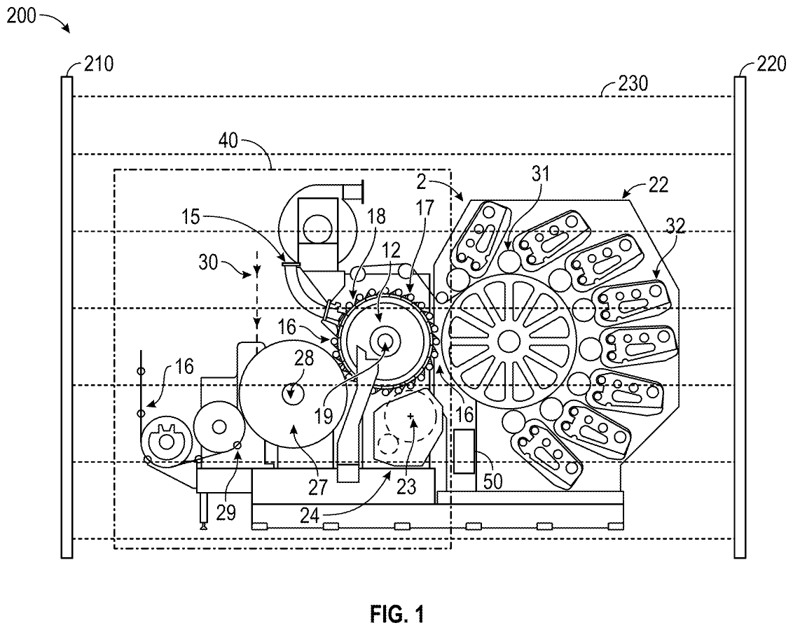

FIG. 2 is an exemplary LiDAR detection system for detecting a human in the vicinity of a machine according to a non-limiting, example embodiment of the disclosed concept;

FIG. 3 is an exemplary LiDAR detection system for detecting a human in the vicinity of a plurality of machines according to a non-limiting, example embodiment of the disclosed concept; and

FIG. 4 is a flow chart for a method of detecting a human using the LiDAR detection system of FIG. 2 according to a non-limiting, example embodiment of the disclosed concept.

### DETAILED DESCRIPTION OF THE INVENTION

It will be appreciated that the specific elements illustrated in the figures herein and described in the following specification are simply exemplary embodiments of the disclosed concept, which are provided as non-limiting examples solely for the purpose of illustration. Therefore, specific dimensions, orientations, assembly, number of components used, embodiment configurations and other physical characteristics related to the embodiments disclosed herein are not to be considered limiting on the scope of the disclosed concept.

Directional phrases used herein, such as, for example, clockwise, counterclockwise, left, right, top, bottom, upwards, downwards and derivatives thereof, relate to the orientation of the elements shown in the drawings and are not limiting upon the claims unless expressly recited therein.

As used herein, the singular form of “a,” “an,” and “the” include plural references unless the context clearly dictates otherwise.

As used herein, “structured to [verb]” means that the identified element or assembly has a structure that is shaped, sized, disposed, coupled and/or configured to perform the identified verb. For example, a member that is “structured to move” is movably coupled to another element and includes elements that cause the member to move or the member is otherwise configured to move in response to other elements or assemblies. As such, as used herein, “structured to [verb]” recites structure and not function. Further, as used herein, “structured to [verb]” means that the identified element or assembly is intended to, and is designed to, perform the identified verb. Thus, an element that is merely capable of performing the identified verb but which is not intended to, and is not designed to, perform the identified verb is not “structured to [verb].”

As used herein, “associated” means that the elements are part of the same assembly and/or operate together or act upon/with each other in some manner. For example, an automobile has four tires and four hub caps. While all the elements are coupled as part of the automobile, it is understood that each hubcap is “associated” with a specific tire.

As used herein, the statement that two or more parts or components are “coupled” shall mean that the parts are joined or operate together either directly or indirectly, i.e., through one or more intermediate parts or components, so long as a link occurs. As used herein, “directly coupled” means that two elements are directly in contact with each other. As used herein, “fixedly coupled” or “fixed” means that two components are coupled so as to move as one while maintaining a constant orientation relative to each other. As used herein, “adjustably fixed” means that two components are coupled so as to move as one while maintaining a constant general orientation or position relative to each other while being able to move in a limited range or about a single axis. For example, a doorknob is “adjustably fixed” to a door in that the doorknob is rotatable, but generally the doorknob remains in a single position relative to the door. Further, a cartridge (nib and ink reservoir) in a retractable pen is “adjustably fixed” relative to the housing in that the cartridge moves between a retracted and extended position, but generally maintains its orientation relative to the housing. Accordingly, when two elements are coupled, all portions of those elements are coupled. A description, however, of a specific portion of a first element being coupled to a second element, e.g., an axle first end being coupled to a first wheel, means that the specific portion of the first element is disposed closer to the second element than the other portions thereof. Further, an object resting on another object held in place only by gravity is not “coupled” to the lower object unless the upper object is otherwise maintained substantially in place. That is, for example, a book on a table is not coupled thereto, but a book glued to a table is coupled thereto.

As used herein, the statement that two or more parts or components “engage” one another means that the elements exert a force or bias against one another either directly or through one or more intermediate elements or components. Further, as used herein with regard to moving parts, a moving part may “engage” another element during the motion from one position to another and/or may “engage” another element once in the described position. Thus, it is understood that the statements, “when element A moves to element A first position, element A engages element B,” and “when element A is in element A first position, element A engages element B” are equivalent statements and mean that element A either engages element B while moving to element A first position and/or element A either engages element B while in element A first position.

As used herein, “correspond” indicates that two structural components are sized and shaped to be similar to each other and may be coupled with a minimum amount of friction. Thus, an opening which “corresponds” to a member is sized slightly larger than the member so that the member may pass through the opening with a minimum amount of friction. This definition is modified if the two components are to fit “snugly” together. In that situation, the difference between the size of the components is even smaller whereby the amount of friction increases. If the element defining the opening and/or the component inserted into the opening are made from a deformable or compressible material, the opening may even be slightly smaller than the component being inserted into the opening. With regard to surfaces, shapes, and lines, two, or more, “corresponding” surfaces, shapes, or lines have generally the same size, shape, and contours.

As used herein, the term “number” shall mean one or an integer greater than one (i.e., a plurality). That is, for example, the phrase “a number of elements” means one element or a plurality of elements. It is specifically noted that the term “a ‘number’ of [X]” includes a single [X].

As used herein, “about” in a phrase such as “disposed about [an element, point or axis]” or “extend about [an element, point or axis]” or “[X] degrees about an [an element, point or axis],” means encircle, extend around, or measured around. When used in reference to a measurement or in a similar manner, “about” means “approximately,” i.e., in an approximate range relevant to the measurement as would be understood by one of ordinary skill in the art.

As used herein, an “elongated” element inherently includes a longitudinal axis and/or longitudinal line extending in the direction of the elongation.

As used herein, “generally” means “in a general manner” relevant to the term being modified as would be understood by one of ordinary skill in the art.

As used herein, “substantially” means “for the most part” relevant to the term being modified as would be understood by one of ordinary skill in the art.

As used herein, “at” means on and/or near relevant to the term being modified as would be understood by one of ordinary skill in the art.

Example embodiments of the disclosed concept provide a LiDAR (light detection and ranging) detection system and method of detecting a human for machine safety. The LiDAR detection system according to the disclosed concept is novel in that it uses one or more LiDAR sensors for detecting human presence within vicinity of a hazardous zone associated with a high-speed moving machine in operation.

Currently, guards or light curtains are used to ensure safety of operators of machines including one or more high-speed moving parts that, when in operation, may pose safety risks to the operators or personnel near them. The guards or light curtains, may, however, have limited field of vision, inaccurately detect human presence, and/or require complex wirings and costly installation due to a large number of sensors needed to protect all sides of the machines. For example, a light curtain has to be wired in a way that it can detect a human moving through a hazardous zone, typically using two sensors to detect the direction of movement. Using the example LiDAR detection system according to the disclosed concept can reduce significantly such complex wirings and the number of sensors needed. By simply positioning one or more LiDAR sensors above and/or around one or more machines, the LiDAR detection system dispenses with the complex wirings, large number of sensors and costly installation as required by the guards or light curtains, and can provide a 360-degree field of vision of what is taking place around the machines at all times. Further, unlike the guards or light curtains that cannot accurately depict if a human or a non-human object (e.g., without limitation, an open door) is in the vicinity of the machine, and thus may trigger an accidental shutdown of the entire machine even upon detection of a non-human object (e.g., without limitation, an open door), the LiDAR detection system can accurately detect an object up to, e.g., without example, 300 meters away and determine if the detected object is indeed a human. The LiDAR detection system can then determine if the human is in the vicinity of a hazardous zone, requiring a shutdown of the machine. If the human is not in the vicinity of a hazardous zone, the LiDAR detection system allows the machine to continue to operate. As such, the LiDAR detection system provides safety measures as appropriate for detected objects and level of safety hazards that the conventional guards and light curtains fail to provide.

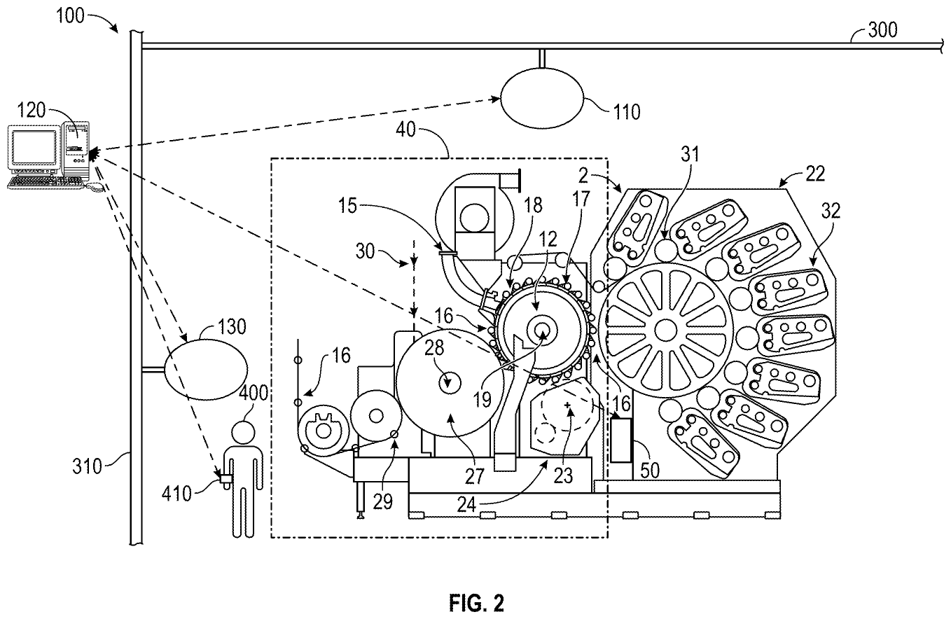

FIG. 2 illustrates a LiDAR detection system 100 according to a non-limiting, example embodiment of the disclosed concept. The LiDAR detection system 100 includes a LIDAR sensor 110 and a controller 120 communicatively coupled to the LiDAR sensor 110. The LiDAR sensor 110 is electrically coupled to a busway 300 and disposed above a machine (e.g., a can decorator) 2. The LiDAR sensor 110 is structured to scan and create at least one of a three-dimensional (3D) image or a 3D point map of a machinery, e.g., without limitation, a can decorator 2 and surroundings thereof. The LiDAR sensor 110 has a measurable range of, e.g., without limitation, 300 meters or more. The LiDAR sensor 110 may be a rotating or spinning LiDAR sensor disposed above the can decorator 2. The LiDAR sensor 110 emits light, receive reflected light, determine distance based on the time it takes to receive the reflected light, and scans an area to create a 3D image or a 3D point map. While FIG. 2 shows the LiDAR sensor 110 coupled to a busway 300, it is for illustrative purposes only, and thus, the LiDAR sensor 110 may be disposed overhead in any other appropriate manner (e.g., affixed to a ceiling of a facility in which the machinery 2 is placed) without departing from the scope of the disclosed concept. The busway 300 is a prefabricated electrical distribution system including conductive elongated bus bars in a protective enclosure, including straight lengths, fittings, devices and accessories. The elongated conductive busbars are structured to carry multi-phase high or low current from a power source (not shown) to a load (here, the can decorator 2). The busway 300 may comprise a plurality of busways 300 electrically connected or interlocked together in end-to-end relation, and thus provide continuous power to one or more loads located at various parts of the facility.

In some examples, one or more additional LiDAR sensors 130 (e.g., a rotating or fixed LiDAR sensors) may be disposed around the can decorator 2 and/or in the vicinity of the hazardous zone 40. For example, one or more additional LiDAR sensors 130 may be disposed on, e.g., without limitation, a vertical bus way and/or a wall 310. By placing one or more additional LiDAR sensors 130 to areas that may not be easily scanned by the overhead LiDAR sensor 110, the LiDAR detection system 100 may increase scannable areas even further, and thus provide a more detailed 3D image of the can decorator 2 and its surroundings. The additional LiDAR sensors may be also communicatively coupled to the controller 120.

The controller 120 is communicatively coupled to the LiDAR sensor 110 in a wired or wireless connection. The controller 120 may be, for example and without limitation, a microprocessor, a microcontroller, or some other suitable processing device or circuitry. It may include memory, which can be any of one or more of a variety of types of internal and/or external storage media such as, without limitation, RAM, ROM, EPROM(s), EEPROM(s), FLASH, and the like that provide a storage register, i.e., a machine readable medium, for data storage such as in the fashion of an internal storage area of a computer, and can be volatile memory or nonvolatile memory. The memory may include a list of parts of the can decorator 2, identity (e.g., without limitation, facial images) of the personnel and device information of the personnel's corresponding user devices 410. The controller 120 may be included in a workstation (e.g., a desk top computer, a laptop computer, etc.) disposed on site or in a local control center that monitors the operations of the can decorator 2.

The controller 120 is structured to collect data including at least one of the 3D image or the 3D point map from the LiDAR sensor 110, analyze the data, detect a human 400 in vicinity of the can decorator 2 and determine if a detected human 400 is too close to the can decorator 2. In some examples, one or more functions of the controller 120 may be integrated into the LiDAR sensor 110. In the examples, the additional LiDAR sensors are disposed around the can decorator, the controller 120 analyzes data from the additional LiDAR sensors in addition to the data from the overhead LiDAR sensor 110 and detects a human. For detecting a human 400, the controller 120 is further structured to detect an object in the vicinity of the can decorator 2 and determine if the detected object is a human 400. If the detected object is not a human (e.g., without limitation, an open door), the controller 120 may allow the can decorator 2 to continue to operate without triggering any alert or shutdown of the can decorator 2. In response to a determination that the detected object is a human 400, the controller 120 is further structured to determine if the detected human 400 is too close to the can decorator 2. The detected human 400 may be too close to the can decorator 2 if the detected human 400 is in the vicinity (e.g., without limitation, within 1 meter) of a hazardous zone 40 of the can decorator 2. A hazardous zone 40 may include one or more high-speed moving parts or motors of the can decorator 2. If the detected human 400 is not in the vicinity of the hazardous zone 40, the controller 120 may allow the can decorator 2 to continue to operate without triggering any alert or shutdown. In response to a determination that the detected human 400 is too close to the can decorator 2, the controller 120 is structured to issue an alert.

The controller 120 may issue an alert to a control panel 50 of the can decorator 2 and/or a user device 410 disposed on the detected human 400. The control panel 50 may be communicatively coupled to the controller 120 in a wired or wireless connection. While FIG. 2 shows that the control panel 50 is disposed within the can decorator 2, it will be understood that the control panel 50 may be disposed at any appropriate location, e.g., without limitation, near or in proximity to the can decorator 2. Upon receipt of the alert, the control panel 50 may perform a partial or full shut down of the can decorator 2 as needed. The controller 120 continuously tracks the detected human 400 and may inform the control panel 50 that the detected human 400 is out of the hazardous zone 40, and thus it is safe to restart all or parts of the can decorator 2. The control panel 50 may restart all or parts of the can decorator 2 when it is informed that the detected person 400 is out of the hazardous zone 40. The user device 410 may be communicatively coupled to the controller 120 via a wireless connection and structured to receive the alert from the controller 120. The user device 120 may be, e.g., a mobile device including a cellular phone or a wearable device such as a wristband, a watch or a headset. An operator or other personnel each may carry the user device 410 on their person and the controller 120 may identify the operator or other personnel and corresponding user devices based on, e.g., without limitation, a list stored in the memory. The alert may include at least one of an alarm, a vibration, or a visual message indicating a specific safety risk to the detected human 400. The alert may instruct the human 400 to move away from the moving part and/or manually shutdown the can decorator 2 partially or fully. The human 400 then can take appropriate safety measures. In some examples, the controller 120 may detect more than one human in the vicinity of the can decorator 2. For example, it may detect an operator working on a part of the can decorator 2 on one side and another person working on another part of the can decorator 2 on another side. In such an example, the controller 120 may transmit an alert to both the operator and the other person to inform the presence of each other. Upon receiving the alert, the operator or the other person can then take an appropriate safety measures (e.g., without limitation, making sure that each person is no longer in the hazardous zone 40 before starting a motor).

In some examples, the controller 120 may also detect if the can decorator 2 is operating normally as a whole or in part. For example, based on the 3D image, the controller 120 can determine if an infeed conveyor 15, a chain-type output conveyor 30, a motor, etc. is operating in accordance with respective specifications from manufacturers. If it is determined that the can decorator 2 is not operating normally, the controller 120 may issue an alert to appropriate personnel, e.g., without limitation, a field engineer, such that inspection, maintenance and/or repair can be performed on the can decorator 2 as appropriate.

Therefore, by simply positioning one or more LiDAR sensors 110 above and/or around one or more machines, the LiDAR detection system 100 avoids the complex wirings, large number of sensors and costly installation required by the guards or light curtains. Further, the LiDAR detection system 100 can provide a 360-degree field of vision of what is taking place around the can decorator 2 at all times, accurately detect a human 400 in the vicinity of hazardous zones 40 and issue an alert such that appropriate safety measures can be taken promptly.

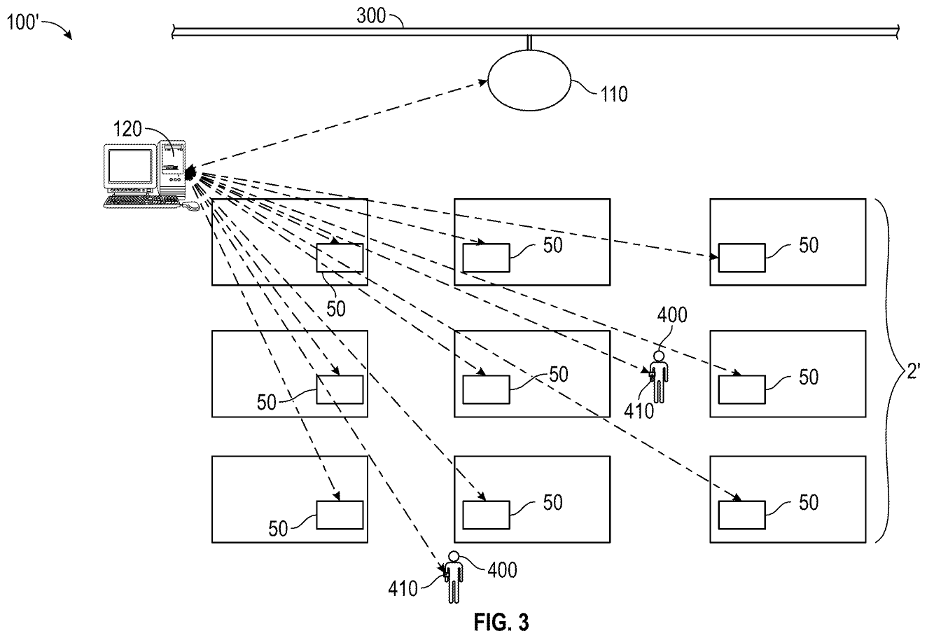

FIG. 3 illustrates a LiDAR detection system 100′ according to a non-limiting, example embodiment of the disclosed concept. The LiDAR detection system 100′ is similar to the LiDAR detection system 100 of FIG. 2, except that it is disposed over a plurality of machines (e.g., without limitation, can decorators) and any additional LiDAR sensors disposed around or in vicinity of hazardous zones are not shown. As such, the description for overlapping components or features are omitted for the sake of brevity. In FIG. 3, a single LiDAR sensor 110 is disposed sufficiently above (e.g., without limitation, at the height of the facility in which the decorator 2 is located) from each machine 2′ such that it can accurately detect a human 400 or object within or near hazardous zones 40 as well as any corners between the can decorators 2′. With the large amount of the data points collected and the comprehensive 3D imaging, the single LiDAR sensor 110 can detect any humans human 400 or objects in the vicinity of one or more can decorators 2′ simultaneously with accuracy and precision.

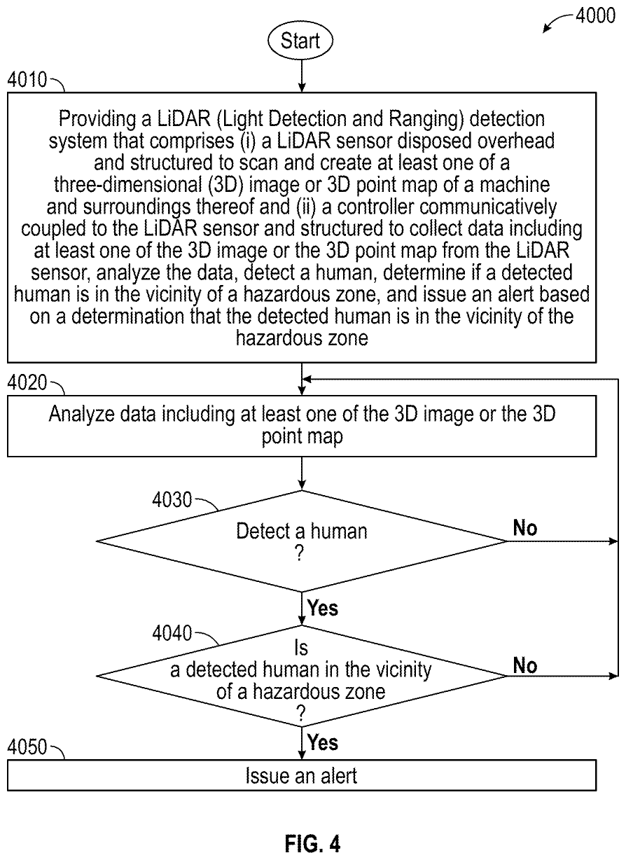

FIG. 4 illustrates a flow chart for a method 4000 of detecting a human in the vicinity of a machine using the LiDAR detection system 100,100′ of FIGS. 2-3. The method 4000 may be performed by the LiDAR detection system 100,100′ or components thereof, such as the LiDAR sensor 110 or the controller 120.

At 4010, a LiDAR detection system is provided. The LiDAR detection system includes a LIDAR sensor disposed overhead and a controller communicatively coupled to the LiDAR sensor. The LiDAR sensor is structured to scan and create at least one of a three-dimensional (3D) image or a 3D point map of the machine (e.g., without limitation, a can decorator) and surroundings thereof. The controller is structured to collect data including at least the 3D image or the 3D point map from the LiDAR sensor, analyze the data, detect a human and determine if a detected human 400 is in the vicinity of a hazardous zone, and issue an alert based on a determination that the detected human is in the vicinity of the hazardous zone.

At 4020, the controller analyzes data including at least one of the 3D image or the 3D point map.

At 4030, the controller detects a human based on the analyzed data. If the controller does not detect a human, the method 4000 returns to 4020.

At 4040, the controller determines if a detected human is in the vicinity of a hazardous zone associated with the machine, the hazardous zone including one or more moving parts of the machine. If the detected human is in the vicinity of a hazardous zone associated with the machine, the method 4000 proceeds to 4050. If no, the method 4000 returns to 4020.

At 4050, the controller issues an alert.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concept which is to be given the full breadth of the claims appended and any and all equivalents thereof.

What is claimed is:

1. A LIDAR (Light Detection and Ranging) detection system for use with a machine, comprising:
a LIDAR sensor disposed overhead and structured to scan and create at least one of a three-dimensional (3D) image or a 3D point map of the machine and surroundings thereof; and
a controller communicatively coupled to the LiDAR sensor and structured to collect data including at least one of the 3D image or the 3D point map from the LiDAR sensor, analyze the data, and detect a human, and determine if a detected human is in the vicinity of a hazardous zone associated with the machine.

2. The system of claim 1, wherein the machine is a machine used in a can manufacturing process.

3. The system of claim 2, wherein the machine is a can decorator.

4. The system of claim 1, wherein the controller is further structured to issue an alert in response to a determination that the detected human is in the vicinity of the hazardous zone.

5. The system of claim 4, wherein the controller is communicatively coupled to a control panel of the machine and the controller transmits the alert to the control panel such that the control panel performs a partial or full shut down of the machine based on the alert.

6. The system of claim 4, wherein the controller is communicatively coupled to a user device disposed on the detected human and the controller transmits the alert to the user device such that the detected person takes a corresponding safety precaution.

7. The system of claim 6, wherein the user device comprises at least a wristband, a watch, a headset or a cellular phone.

8. The system of claim 1, further comprising one or more additional LiDAR sensors disposed around the machine or in the vicinity of the hazardous zone.

9. The system of claim 1, wherein the controller is further structured to:
detect if the machine is operating normally; and
in response to a determination that the machine is not operating normally, transmit an alert indicative of the determination such that inspection, maintenance or repair is performed on the machine subsequently.

10. The system of claim 1, wherein the LiDAR sensor is a rotating sensor with a 360-degree field of vision.

11. A LIDAR (Light Detection and Ranging) detection system for use with a plurality of machines, comprising:
a LiDAR sensor disposed overhead and structured to scan and create at least one of a three-dimensional (3D) image or a 3D point map of the plurality of machines and surroundings thereof; and
a controller communicatively coupled to the LiDAR sensor and structured to collect data including at least one of the 3D image or the 3D point map from the LiDAR sensor, analyze the data, and detect a human, and determine if a detected human is in the vicinity of a hazardous zone associated with one or more machines of the plurality of machines.

12. The system of claim 11, wherein the plurality of machines comprises machines used in a can manufacturing process.

13. The system of claim 12, wherein the machines are can decorators.

14. The system of claim 11, wherein the controller is further structured to issue an alert in response to a determination that the detected human is in the vicinity of the hazardous zone.

15. The system of claim 14, wherein the controller is communicatively coupled to a control panel of the machine and the controller transmits the alert to the control panel such that the control panel performs a partial or full shut down of the machine based on the alert.

16. The system of claim 14, wherein the controller is communicatively coupled to a user device disposed on the detected human and the controller transmits the alert to the user device such that the detected person takes a corresponding safety precaution.

17. The system of claim 11, further comprising one or more additional LiDAR sensors disposed around the machine or in the vicinity of the hazardous zone.

18. The system of claim 11, wherein the LiDAR sensor is a rotating sensor with a 360-degree field of vision.

19. A method of detecting a human in the vicinity of a machine, the method comprising:
providing a LiDAR (Light Detection and Ranging) detection system that comprises (i) a LiDAR sensor disposed overhead and structured to scan and create at least one of a three-dimensional (3D) image or a 3D point map of the machine and surroundings thereof, and (ii) a controller communicatively coupled to the LiDAR sensor and structured to collect data including at least one of the 3D image or the 3D point map from the LiDAR sensor, analyze the data, and detect a human, and determine if a detected human is in the vicinity of a hazardous zone associated with the machine;
analyzing data including at least one of the 3D image or the 3D point map;
detecting a human based on the analyzed data; and
determining if a detected human is in the vicinity of a hazardous zone.

20. The method of claim 19, further comprising:
in response to a determination that the detected human is in vicinity of the hazardous zone, issuing an alert to at least one of a control panel of the machine or a user device disposed on the detected person.
